(19) United States
(12) Patent Application Publication
(10) Pub. No.: US 2026/0070309 A1
(43) Pub. Date: Mar. 12, 2026

(54) POLYHYDROXYALKANOATE-BASED PACKAGING FILMS AND ARTICLES MADE THEREWITH

(71) Applicant: Newlight Technologies, Inc., Huntington Beach, CA (US)

(72) Inventors: Garrett Sell, Huntington Beach, CA (US); Scott William Wollack, Huntington Beach, CA (US); Jon Knight, Huntington Beach, CA (US)

(73) Assignee: Newlight Technologies, Inc., Huntington Beach, CA (US)

(21) Appl. No.: 18/873,051

(22) PCT Filed: Jun. 14, 2023
(86) PCT No.: PCT/US2023/068407

§ 371 Date: Dec. 9, 2024

Related U.S. Application Data
(60) Provisional application No. 63/352,956, filed on Jun. 16, 2022.
(60) Provisional application No. 63/410,555, filed on Sep. 27, 2022.

(51) Int. Cl. B32B 7/12; B32B 1/00; B32B 27/10; B32B 29/06; C08L 67/04

(52) U.S. Cl. CPC B32B 7/12; B32B 1/00; B32B 27/10; B32B 29/06; C08L 67/04; B32B 2255/12; B32B 2255/26; B32B 2270/00; B32B 2307/4026; B32B 2307/7163; B32B 2307/718; B32B 2307/7246; B32B 2307/7376; B32B 2307/746; B32B 2439/70

(57) ABSTRACT

The present specification generally relates to aqueous based compositions of poly hydroxyalkanoate (PHA) and polymer blends of PHA for use with food contact items and similar packaging films. In particular, the invention pertains to a composition and an article of manufacture having a coating or laminate made up of poly(3-hydroxybutyrate) homopolymer (PHB) having a final coating thickness in the range of 0.1 to 2.0 mil thickness dry weight, or in a weight basis of about 3 to 70 grams per square meter coat weight basis. Methods of making the compositions of the invention are also described. The invention also includes articles and films comprising the compositions.

### CROSS-REFERENCE TO RELATED APPLICATIONS

This application claims the benefit of United Provisional Patent Application No. 63/352,956, filed Jun. 16, 2022 and United Provisional Patent Application No. 63/410555, filed Sep. 27, 2022, the entire contents of each of which is incorporated in tits entirety by reference herein.

### FIELD

The present specification generally relates to aqueous based compositions of polyhydroxyalkanoate (PHA) and polymer blends of PHA for use with food contact items and similar packaging films. In particular, the invention pertains to a composition and an article of manufacture having a layer, coating or laminate made up of poly(3-hydroxybutyrate) homopolymer (PHB) having a final layer thickness in the range of 0.1 to 2.0 mil thickness dry weight, or in a weight basis of about 3 to 70 grams per square meter coat weight basis. Methods of making the compositions of the invention are also described. The invention also includes articles and films comprising the compositions.

### BACKGROUND

In the first decade of this century, more plastic was produced than all the plastic in history up to the year 2000. The use of plastic materials on a large scale has represented a mark in the history of technological development; however, the increasing utilization of these materials is resulting in serious environmental problems. These materials, in general, take approximately 500-1,000 years to degrade naturally, meaning that virtually every piece of synthetic plastic ever made still exists today in some shape or form. In the case of petrochemical-derived plastic resins, approximately 900 billion pounds worldwide are produced annually and it is estimated that this number will continue to increase each year by approximately four percent. Of this annual worldwide production, it is estimated that approximately 10 percent or 90 billion pounds enters the earth's oceans on an annual basis, resulting in the deaths of thousands of seabirds and sea turtles, seals and other marine mammals each year after either ingesting the plastic or getting entangled in it. Thus, a need exists for reducing the negative impacts of synthetic/petro-chemical based plastics, in part by providing improved alternative products, such as paperboard products, and/or improved barrier or sealing properties for such products.

### SUMMARY

In view of these problems, more than 60 countries have introduced levies and bans to combat single-use plastic waste, according to the U.N. Environment, an agency of the United Nations. Considering the relevance of these facts, the market potential for using biodegradable material are receiving worldwide attention. The applications for these biodegradable biopolymers in the market involve products, such as disposable materials, including but not limited to packaging, diapers, food service items, such as dishware, drinkware, to go containers, and cutlery; cosmetic, agrochemical, and aquatic products; and medical and pharmaceutical articles, such as microencapsulating drugs of controlled release, medical sutures and fixation pins for bone fractures, due to their total biocompatibility and mild rejection from the receiving organism.

Disposable food service items may readily be advantageously fabricated from substrates such as paperboard which decompose relatively quickly after disposal; however, a simple, uncoated paperboard substrate generally performs poorly as a food service item because the paperboard will rapidly soak up water and/or grease which compromises the strength of the paperboard. Consequently, food service items made from paperboard are typically coated with a thin synthetic plastic layer form using polymers such as polyethylene (PE), polypropylene (PP), or polyethylene terephthalate (PET) to provide improved water and grease resistance. However, as discussed previously such plastics do not readily degrade or decompose after disposal and thus the plastic pollution problem continues to be exacerbated.

Coatings made from synthetic plastics such as polyethylene (PE), polypropylene (PP), polylactic acid (PLA), or polyethylene terephthalate (PET) may significantly improve the resistance of the paperboard to water and/or grease absorption; however, such polymers do not readily degrade or decompose after landfill disposal. Thus, the paperboard items coated with such polymers may subsist in landfills for centuries after disposal and are not capable of being recycled without the use of special processes.

An important family of the biodegradable biopolymers are polyhydroxyalkanoates (PHAs), which are polyesters naturally biosynthesized by over 300 different microorganisms, serving as natural energy reserves for the microbe. One of the simplest and most important polymers in the PHA biopolymer family is polyhydroxybutyrate (PHB). The commercial interest in PHBs is directly related not only to the biodegradability and biocompatibility characteristics but also to their thermo-mechanical properties and production costs. In addition, there is a growing body of evidence that PHBs, when ingested by an animal, can act as microbial control agents of the gut flora, which may have a positive impact on weight gain, growth rate and overall survival (Y. Duan, et al., Effect of dietary poly-□-hydroxybutyrate (PHB) on growth performance, intestinal health status and body composition of Pacific white shrimp Litopenaeus vannamei, Fish & Shellfish Immunology, 60: 520-528 (2017); and E. H. Najdegerami, et al., Effects of poly-□-hydroxybutyrate (PHB) on Siberian sturgeon (Acipenser baerii) fingerlings performance and its gastrointestinal tract microbial community, FEMS Microbiol Ecol., 79: 25-33 (2012).

Applications of PHA materials onto paperboard is attractive due to the performance and sustainability attributes. Melt extrusion coating of PHA can be challenging due to the thermal sensitivity of PHA systems. It is advantageous to apply solution-based layers to paperboard surfaces to better manage the applied thermal history to the polymer; this will result in higher performing coatings which are effective at lower coat weights. This will apply to PHB based systems.

Thus a need exists for providing suitable barrier and/or sealing properties for paperboard products while improving the degradability and composability of such products. It is a particular object of the invention to find such a solution which does not add unreasonable cost to the manufacturing process and which does not adversely affect to an unreasonable degree other desirable properties of the applied layer, such as optical and mechanical properties, for example.

Several embodiments provided for herein address a need for improving the degradability and composability of paperboard products without compromising the barrier and/or sealing properties.

In several embodiments, the invention further provides aqueous PHA polymer solutions which are relatively inexpensive and easy to manufacture.

In general, embodiments of the present invention describe an environmentally sustainable composition that is useful for the manufacture of polyhydroxyalkanoate-based articles. In particular, embodiments of the invention pertains to an article of manufacture having a continuous or discontinuous coating matrix wherein the coating matrix is made up of poly(3-hydroxybutyrate) homopolymer (PHB).

The above and other needs are met by a biodegradable aqueous dispersion for coating food contact substrates. According to one embodiment, the coatings may be applied in such a way that final coating thickness can range from about 0.1 to about 2.0 mil thickness dry weight (such as, about 0.1, about 0.2 about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.8, about 1.9, about 2.0, or in a weight basis of about 3 to about 70 grams per square meter (g/m²) coat weight basis (such as about 3-5 g/m², about 5-10 g/m², about 10-20 g/m², about 20-25 g/m², about 25-30 g/m², about 30-35 g/m², about 35-40 g/m², about 40-45 g/m², about 45-50 g/m², about 50-55 g/m², about 55-60 g/m², about 60-65 g/m², about 65-70 g/m², or any weight basis therebetween, including endpoints).

Alternatively, the aqueous polyhydroxyalkanoate composition of embodiments of the present invention may comprise a mixture of two polymers, (i) a PHB and (ii) amorpohous polyhydroxyalkanoate (aPHA), in combination with a co-agent. Preferably, the composition of embodiments of the present invention, which is biodegradable and biocompatible, comprises about 88% to about 97.5% by weight PHB and between about 2.5 to about 30% aPHA of the total PHA.

The aqueous polyhydroxyalkanoate compositions can be made by any suitable method, using any suitable order of processing. For example, in one embodiment, the method comprises the steps of suspending PHA polymers in the form of a fine particle size powder, extracted from microbial biomass, in an aqueous media, held in an agitator tank and the suspension is sprayed over a paperboard substrate. The paperboard is then dried and heated above the melting point of the PHA polymer. The dry PHA composition then melts, creating a sealed layer of PHA over the paperboard surface, either via continuous or discontinuous coating matrix, resulting in appropriate sealing and barrier properties. Alternatively, PHA powder and an amorphous PHA powder, both of which are extracted from a microbial biomass, in the form of a fine particle size powder, arc blended by dry-blending the components at a pre-determined ratio, mixed and processed to form a homogenous blend prior to suspending in an aqueous solution. The aqueous solution is then held in an agitator tank prior to being sprayed onto the paperboard. In the event that the aqueous solution is to be applied to the paperboard by some means other than spray coating, such as but not limited to gravure, reverse gravure, Mayer rod, knife over roll coating, direct extrusion, die, slot die, and dip coating, then it may be advantageous to add to the PHA polymer or blend of polymers a co-agent.

The novel blended polyhydroxyalkanoate compositions of embodiments of this invention can be fabricated into commercially useful articles, such as but not limited to dishware, drinkware, and to go, carry-out, or other short term food storage containers.

Also provided herein are articles made from any of the PHA or blended compositions of the embodiments of the inventions disclosed herein.

Optionally, additives may be added to the aqueous blended suspension. Such additives may be mixed at a suitable time during the processing of the components for forming the blend suspension. One or more additives are included in the blended suspension to impart one or more selected functional characteristics to the blended suspension and article made therefrom. Examples of additives that may be included in the present invention include, but are not limited to, rheology modifiers, cross-linking agents (peroxide based and other), tackifiers, barrier enhancers such as inorganic materials such as clays, kaolin, micas, carbonates, and organic cellulosic fibers and crystallites (micro and nano scale), antioxidants, thermal and UV stabilizers, acid and base scavengers, fillers of both organic and inorganic components, water activity modifiers, plasticizers, and other polymeric functional additives, heat stabilizers, process stabilizers, antioxidants, slip/antiblock agents, pigments, lubricants, pigments, dyes, flow promoters plasticizers, processing aids, branching agents, strengthening agents, nucleating agents (discussed in further detail below), radical scavengers or a combination of one or more of the foregoing functional additives.

The fabricated articles of manufacture, as a waste product entering the environment, may then be degraded into monomeric units or benign low molecular weight species, which have been shown to be beneficial to growth performance, intestinal digestive, and immune function.

In several embodiments, there is provided a product in the form of a food service item comprising a layer forming a moisture barrier, said product comprising a paperboard substrate having at least two surfaces wherein one of said surfaces comes in contact with food, wherein the moisture barrier layer is coated directly on the surface of the paperboard that comes in contact with food and comprises at least one polyester polymer having a final thickness in the range of from 0.1 to 2.0 mil thickness dry weight.

In several embodiments, the polyester polymer has a weight basis of about 3 to 70 grams per square meter coat weight basis, such as for example, about 3-5 g/m², about 5-10 g/m², about 10-20 g/m², about 20-30 g/m², about 30-40 g/m², about 40-50 g/m², about 50-60 g/m², about 60-70 g/m², and any weight basis therebetween, including endpoints.

In several embodiments, the paperboard substrate is in the shape of a plate, e.g., round, ovoid, square or other geometric shape. In several embodiments, the paperboard substrate is in the shape of a bowl. In several embodiments, the paperboard substrate is in the shape of a cup, glass, or a mug. In several embodiments, the paperboard substrate is in the shape of a to go container, such as a clamshell container or a container with a bottom and side surfaces that define a recess into which food is placed and folding/sealing upper flaps to secure the container closed.

In several embodiments, the moisture barrier layer is applied to said paperboard substrate as a spray. In several embodiments, the spray comprises an aqueous solution of PHA. In several embodiments, the spray comprises an aqueous solution of PHA blended with amorphous PHA (aPHA). In several embodiments, the PHA in the PHA blend is in the range of 70% to 97.5% by weight (e.g., 70-75%, 75-80%, 80-85%, 85-90%, 90-95%, or 95-97.5%) of the combined content of the PHAs in the PHA blend, and the content of the aPHA in the PHA blend is in the range of 2.5% to 30% by weight (e.g., 2.5-5%, 5-10%, 10-15%, 15-20%, 20-25%, or 25-30%) of the combined content of the PHAs in the PHA blend.

In several embodiments, the amorphous polymer is a PHA having a glass transition temperature (Tg) less than about 20° C., and a melting temperature (TM) of between about 80° C. to 180° C.

In several embodiments, the product further comprises one or more of a nucleating agent; a free radical initiator, a branching agent, a coupling agent/coagent, thermal stabilizers, antioxidants, slip agents, colorants and other functional additives.

In several embodiments, the polyester polymer is selected from a poly(3-hydroxybutyrate) homopolymer (PHB), polyhydroxyvalerate (PHV), polyhydroxybutyrate-covalerate (PHBV), polyhydroxyhexanoate (PHHx), poly 3-hydroxyalkanoates (e.g., poly 3-hydroxypropionate (hereinafter referred to as P3HP), poly 3-hydroxybutyrate (hereinafter referred to as PHB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)), poly 3-hydroxybutyrate-co-3-hydroxypropionate (hereinafter referred to as PHB3HP), poly 3-hydroxybutyrate-co-4-hydroxybutyrate (hereinafter referred to as PHB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV) and various combinations thereof, including polymer blends.

In several embodiments, there is provided a biodegradable aqueous dispersion for coating food contact substrates, the dispersion comprising: PHA blended with an amorphous PHA (aPHA) wherein: the content of the PHA in said blend is in the range of about 70% to about 97.5% by weight (e.g., 70-75%, 75-80%, 80-85%, 85-90%, 90-95%, or 05-97.5%) of the combined content of the PHAs in said blend, the content of the aPHA in said blend is in the range of about 2.5% to about 30% by weight (e.g., 2.5-5%, 5-10%, 10-15%, 15-20%, 20-25%, 25-30%, or any amount by weight therebetween, including endpoints) of the combined content of the PHAs in said blend.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### DETAILED DESCRIPTION

The present specification generally relates to a composition for the manufacture of bio-degradable, bio-compostable, ocean degradable, biocompatible articles that contain a bio-based thermopolymer component applied on the surface of a substrate. While the substrate that is the focus of several embodiments of the present invention is paper or paperboard, this composition and techniques could certainly be broadly applied to an substrate, such as but not limited to, fibers, cellulosic, starch, metallic, and other natural substrates. In particular, it has been found, in accordance with the practice of certain embodiments of this invention, that marked improvement in the barrier and/or sealing properties for paperboard products can be achieved by suspending polyhydroxyalkanoate (PHA) in the form of a fine particle size powder in an aqueous solution and applying such solution to a paperboard thereby producing a bio-degradable, bio-compostable, ocean degradable paperboard article having suitable barrier and/or sealing properties. Alternatively, PHA, and more specifically PHB, and an amorphous polyhydroxyalkanoate (aPHA) with a glass transition temperature of below 20° C. both in the form of a fine particle size powder, are blended by dry-blending the components at a pre-determined ratio, mixed and processed to form a homogenous blend prior to suspending in an aqueous solution and the suspension may be sprayed onto a paperboard. The polyhydroxyalkanoate components of embodiments of this invention comprise a poly(3-hydroxybutyrate) homopolymer (PHB) and a discrete phase made up of an amorphous polyhydroxyalkanoate (aPHA) with a glass transition temperature (T_{g}) below 20° C. and a melting temperature (T_{M}) of 80° C. to 180° C.

To coat paperboard with a PHA based film, the following application methodology can be used (as a non-limiting example): PHA powder in the form of a fine particle size powder is first suspended in an aqueous media. The PHA suspension is then held in an agitator tank prior to being applied over the at least one food contact surface of the paperboard. The paperboard is then dried and heated above the melting point of the PHA polymer thus creating a sealed coating of PHA over the paperboard surface, either via continuous or discontinuous coating matrix resulting in appropriate sealing and barrier properties. There are several considerations for the described application on of which is the use of multiple polymer layers applied over each other. These different layers can have differently polymer compositions, with the different compositions providing different properties, such as strength and oxygen barrier.

Alternatively, the polymer suspension described above can take the form of a PHA/aPHA blend. The PHA/aPHA blend may then be suspended in an aqueous solution and held in an agitator tank prior to being applied over at least one food contact surface of the paperboard. The paperboard is then dried and heated above the melting point of the polymer blend thus creating a sealed coating of PHA/aPHA over the paperboard surface, either via continuous or discontinuous coating matrix resulting in appropriate sealing and barrier properties.

Drying of water and any other co-solvents should be executed at low temperatures to prevent hydrolytic degradation of the PHA polymer. Drying should leverage convection or vacuum to augment drying times, while maintaining low product exposure temperatures. Until the PHA coating reaches a moisture content at or below 0.3% w/w, the coating should not exceed 90° C. Once sufficiently dried, the PHA film may be melted at temperatures below the degradation temperature of the PHA film which is typically between about 170° C. and 200° C. Temperature in excess may result in unfavorable thermal degradation.

The process by which PHA suspension is applied, dried, and melted onto a paperboard substrate must consider the characteristics of PHA for successful adhesion. Nozzle type and size should be tailored to the final particle size of the suspension. The suspension of PHA powder must also be optimized for droplet adhesion as well as droplet spread upon contact with the paper substrate. Other additives, such as co-solvents may be considered for this purpose. Simple alcohols and ketones may serve for the purpose of droplet adhesion and spread.

The coatings may be applied in such a way that final layer thickness can range from 0.1 to 2.0 mil thickness dry weight, or in a weight basis of about 3 to 70 grams per square meter coat weight basis, or other dry weights or weight bases as provided for herein. Furthermore, there are limitations to the ability of paperboard to maintain dimensional stability upon receiving polar solvent-based coatings; as a result, percent solids of the solution-based coating system are critical; percent solids should ideally range from about 10 wt % to 60 wt % solids in polar solvents (e.g, 10-15%, 15-20%, 20-25%, 25-30%, 30-35%, 35-40%, 40-45%, 45-50%, 50-55%, or 55-60%, or any percent of solids between those values listed, including endpoints). Polar solvent systems contemplated include but are not limited to water, alcohols, polyols, ethers, and polyethers.

Modular application and drying steps provide value as balancing free solvent affecting dimensional stability of the paperboard with free solvent available to carry the PHA is critical. An example of this is to apply PHA in multiple stations of low coat weight, while drying between stations, repeatedly.

While it is contemplated that the coating process using the PHA or polymer blend, that is PHA/aPHA, is accomplished using a spray nozzle it is well within the teachings of the present invention to use more common coating methods including but not limited to, gravure, reverse gravure, Mayer rod, knife over roll coating, direct extrusion, die, slot die, dip coating, and spray technologies. These coatings may be applied during the paper making process, or after the paper making process in a post-production coating step. In each of these instances however, the suspension of PHA powder must be executed in a manner that prevents excessive settling of the PHA granules. If an agitator tank is not used, one method of settling prevention is with formulation of the aqueous solution using surfactants, dispersants, and/or viscosity modifiers that may be incorporated to help maintain a uniform suspension.

Both ionic and non-ionic surfactants will aide in PHA suspension by reducing the tendency for PHA granules to agglomerate. Some examples of non-ionic surfactants include Ethoxylated non-ionic surfactants such as alcohol ethoxylates, ethoxylated fatty acids, such as those listed under the DOW trade name “Ecosurf,” etc. ; Polysorbates, and other ethoxylated sorbitan esterified with fatty acids; polyethylene block copolymers such as those listed under the DOW trade name of “Tergitol;” other classes of polar group modified aliphatic compounds.

Additionally common anionic surfactants can be used to suspend PHAs. Sulfate modified aliphatic compounds are useful, including Sodium dodecyl sulfate (SDS, SLS), etc.

Common dispersants, such as polyvinyl pyrrolidone (PVP), partially and fully saponified Polyvinyl acetates (PVAc, PVOH) and Ethylene vinyl acetates (EVAc and EVOH), Polyacrylic Acids (PAA), sodium hexameta phosphate (SHP), or the sodium salt of EDTA (EDTA-Na) may also be incorporated to prevent the settling tendency of PHA granules. Both inorganic and organic viscosity modifiers may be considered for prevention of PHA settling behavior. For example, fumed silicas (inorganic), cellulosic (organic), or synthetics (organic) rheology modifiers may be incorporated into the suspension. pH of Solution & Extraction

The pH of the solution must be considered for the preservation of PHA melt stability upon final drying and melting. Depending on other formulation additives present in the suspension, the pH must be adjusted to between 2 and 7, or more precisely between 2.5 and 4.5. Alternatively, de-ionized water may be used as the suspension solvent without pH adjustment.

There are two methodologies for preparing the described PHA suspension. The process of PHA extraction from microbial biomass according to the present invention is accomplished using an aqueous process. The final stage of the process may therefore serve as the basis for the final spray coating formulation. First, however, that slurry would need to be purified or diluted by filtration or gravity separation to purge dissolved impurities from the suspension. Once purified or diluted, the slurry may be adjusted in pH and composition according to the class of additives described in further detail below, then applied to the paperboard substrate. The second methodology for preparing a PHA suspension is to utilize the final purified dried PHA extract. Already purified, the dry powder would simply be resuspended into a preformulated aqueous media, tailored for suspension stability per the additive classes described in further detail below.

The two polymers, PHA and aPHA, which are employed in forming the blended polyhydroxyalkanoate composition of the present invention are discussed in further detail below and may include homopolymers, copolymers, and blends thereof. Suitable compatibilizers of the invention include, but are not limited to polypropylene-co-acrylic acids, polypropylene-g-maleic anhydride, polyethylene-g-maleic anhydride, polyethylene-g-maleic anhydride-co-ethyl acrylate, polyethylene-g-maleic anhydride-co-methyl acrylate, polyethylene-co-butylene/styrene, polyethylene-co-butylene/succinic anhydride, polyethylene-co-acrylic acid, polyethylene-co-methyl acrylate, polyurethanes, thermoplastic polyurethanes, thermoplastic polyesters, thermoplastic polyethers, thermoplastic polyether esters, thermoplastic polyol/copolyol polyethylene-co-butyl acrylate, thermoplastic polycaprolactones, polybasic acids, polyglycols, substituted fatty acids, polyester adipates, succinic polyesters, polyoxyalkylenes, polypropylene adipate, polyester glutarate, polyethylene glycol monooleate, trimethylcitrate, epoxidized soyabean oil, acetyl tri-n-butyl citrate, polyester sebacate, neopentylglycol-adipicacid-caprolactone, trifunctional polyester adipates, epoxidized linseed oil, castor oil, and glutaric polyesters, allowing for the formation of a blended composition having two discrete phases. Surprisingly, the inventors have discovered that multi-phase block co-polymers arc uniquely qualified to aid in the miscibility of the aPHA and PHA polymer, thus allowing for the formation of a blended composition useful in the manufacture of bio-degradable, ocean degradable and bio-compostable articles with adequate strength and durability. Added benefits of the blended polyhydroxyalkanoate/amorphous PHA composition are that it is bio-degradable, ocean degradable, bio-compostable, and bio-compatible. The blended composition, as an article of manufacture will eventually degrade in the environment releasing natural PHA polymer residue, such as but not limited to poly-3-hydroxybutyrate (PHB) that may then be decomposed into water-soluble short-chain fatty acid monomer which have been shown to be beneficial to growth performance, intestinal digestive and immune function in animal studies.

The mechanism for the miscibility of this polymer-polymer interface is believed to be due to increased intermolecular forces between polymer chains thereby reducing interfacial tension and allowing the formation of desirable phase morphology. While not intending to be bound by any particular theory, possible factors that influence the miscibility include molecular weight, molecular weight distribution, hydrogen bonding, vander Waals forces, dielectric constant, polarity of the chains (dipole moment), end-groups, and the purity of the polymers. It is believed that the multi-phase block copolymer reduces the interfacial tension between that of the PHA polymer and the amorphous polyhydroxyalkanoate.

The novel blended compositions disclosed herein comprise, in some embodiments: (a) from about 68 percent by weight to about 97.5 percent by weight PHA and (b) from about 2.5 percent by weight to about 32 percent by weight amorphous PHA. It has been discovered that the desired properties can be tuned by varying the concentration of the components. For example, formulations having from about 68 percent by weight to about 97.5 percent by weight PHA and (b) from about 2.5 percent by weight to about 32 percent by weight aPHA will have mechanical properties which may create suitable barrier and/or sealing properties.

Paperboard items, in general, require suitable barrier and/or sealing properties, easy processability, disposability, ocean degradability, biodegradability and biocompostability. Optionally, additives such as, but not limited to, pigments, nucleating agents, stabilizers, coupling agents, free radical initiators, and strengthening agents may be added to the blended composition of the present invention. The additives contemplated are described in further detail below.

It is to be understood that throughout this specification when PHA is referred to it is contemplated that these terms include, but are not limited to, homopolymers, copolymers, and blends thereof, that may or may not be food grade. As used herein, the terms “functional properties” and “functional characteristics” shall be given their ordinary meanings and shall also refer to the specification, features, qualities, traits, or attributes of PHA. The functional characteristics of the PHA include, but are not limited to, molecular weight, polydispersity and/or polydispersity index, melt flow and/or melt index, monomer composition, co-polymer structure, melt index, non-PHA material concentration, purity, impact strength, density, specific viscosity, viscosity resistance, acid resistance, mechanical shear strength, flexural modulus, elongation at break, freeze-thaw stability, processing conditions tolerance, shelf-life/stability, hygroscopicity, and color. As used herein, the term “polydispersity index” (or PDI), shall be given its ordinary meaning and shall be considered a measure of the distribution of molecular mass of a given polymer sample (calculated as the weight average molecular weight divided by the number average molecular weight). The fully amorphous PHAs (having 0% crystallinity and no observed melting point temperature) and mostly amorphous phase PHAs includes polymers of 4-hydroxybutyrate, 3-hydroxyhexanoate, 5-hydroxyvalerate, 3-hydroxyhexanoate, 3-hydroxyoctanoate, or other 3-hydroxy alkanoic acids with higher numbers of carbons as pendant groups including those derived from fatty acids and combinations thereof. The resultant PHA can be a blend, copolymer, mixture or combination of one, two or three or more PHA components. Without intending to be limited to a specific theory, the inventors theorize that when the aPHA polymer is blended with other polymers, it readily forms a separate discrete phase which imparts a toughening effect on the overall polymer blend.

Polyhydroxyalkanoates are biological polyesters synthesized by a broad range of natural and genetically engineered microorganisms and microorganism enzymes as well as genetically engineered plant crops (Braunegg, et al., J. Biotechnology, 65:127-161 (1998); Madison and Huisman, Microbiology and Molecular Biology Reviews, 63:21-53 (1999); Poirier, Progress in Lipid Research 41:131-155 (2002)). These polymers are biodegradable thermopolymer materials, can be produced from renewable resources, and have the potential for use in a broad range of industrial applications (Williams & Peoples, CHEMTECH 26:38-44 (1996)). Useful microbial strains for producing PHAs, include Alcaligenes eutrophus (renamed as Ralstonia eutropha), Alcaligenes latus, Azotobacter, Aeromonas, Comamonas, Pseudomonads, and genetically engineered organisms including genetically engineered microbes such as Pseudomonas, Ralstonia and Escherichia coli.

In general, PHA is formed by enzymatic polymerization of one or more monomer units. Over 100 different types of monomers have been incorporated into the PHA polymers (Steinbuchel and Valentin, FEMS Microbiol. Lett., 128:219-228 (1995). Examples of monomer units incorporated in PHAs include 2-hydroxybutyrate, lactic acid, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HHep), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

The terms “PHA”, “PHAs”, and “polyhydroxyalkanoate”, as used herein, shall be given their ordinary meaning and shall include, but not be limited to, polymers generated by microorganisms or microorganism enzymes; biodegradable and/or biocompatible polymers that can be used as alternatives to petrochemical-based plastics such as polypropylene, polyethylene, and polystyrene; polymers produced by bacterial fermentation of sugars, lipids, or gases; thermopolymer or elastomeric materials derived from microorganisms or microorganism-derived enzymes; and/or polymers generated by chemical reaction not inside of microbial cell walls. PHAs include, but are not limited to, polyhydroxybutyrate (PHB), polyhydroxyvalerate (PHV), polyhydroxybutyrate-covalerate (PHBV), polyhydroxyhexanoate (PHHx) and blends thereof as discussed in detail below, as well as both short chain length (SCL), medium chain length (MCL), and long chain length (LCL) PHAS.

In some embodiments, the PHA is a homopolymer (all monomer units are the same). Examples of PHA homopolymers include poly 3-hydroxyalkanoates (e.g., poly 3-hydroxypropionate (hereinafter referred to as P3HP), poly 3-hydroxybutyrate (hereinafter referred to as PHB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)).

In certain embodiments, the starting PHA is a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as PHB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

By selecting the monomer types and controlling the ratios of the monomer units in a given PHA copolymer a wide range of material properties can be achieved. Although examples of PHA copolymers having two different monomer units have been provided, the PHA can have more than two different monomer units (e.g., three different monomer units, four different monomer units, five different monomer units, six different monomer units). An example of a PHA having 4 different monomer units would be PHB-co-3HH-co-3HO-co-3HD or PHB-co-3-HO-co-3HD-co-3HDd (these types of PHA copolymers are hereinafter referred to as PHB3HX). Typically where the PHB3HX has 3, or more, monomer units the 3HB monomer is at least 70% by weight of the total monomers, preferably 85% by weight of the total monomers, most preferably greater than 90% by weight of the total monomers for example 92%, 93%, 94%, 95%, 96% by weight of the copolymer and the HX comprises one or more monomers selected from 3HH, 3HO, 3HD, 3HDd.

The homopolymer (where all monomer units are identical) PHB and 3-hydroxybutyrate copolymers (PHB3HP, PHB4HB, PHB3HV, PHB4HV, PHB5HV, PHB3HHP, hereinafter referred to as PHB copolymers) containing 3-hydroxybutyrate and at least one other monomer are of particular interest for commercial production and applications. It is useful to describe these copolymers by reference to their material properties as follows. Type 1 PHB copolymers typically have a glass transition temperature (Tg) in the range of 6° C. to −10° C., and a melting temperature Tₘ of between 80° C. to 180° C. Type 2 PHB copolymers typically have a Tg of −20° C. to −50° C. and Tₘ of 55° C. to 90° C. and are based on PHB4HB, PHB5HV polymers with more than 15% 4HB, SHV, 6HH content or blends thereof. In particular embodiments, the Type 2 copolymer have a phase component with a Tg of −15° C. to −45° C. and no Tₘ.

As used in the present invention, the molecular weight of PHA ranges between about 5,000,000 and about 2,500,000 Daltons, between about 2,500,000 and about 1,000,000 Daltons, between about 1,000,000 and about 750,000 Daltons, between about 750,000 and about 500,000 Daltons, between about 500,000 and about 250,000 Daltons, between about 250,000 and about 100,000 Daltons, between about 100,000 and about 50,000 Daltons, between about 50,000 and about 10,000 Daltons, and overlapping ranges thereof.

In determining the molecular weight, techniques such as gel permeation chromatography (GPC) can be used. In such methodology, a polystyrene standard is utilized. The PHA can have a polystyrene equivalent weight average molecular weight (in Daltons) of at least 500, at least 10,000, or at least 50,000 and/or less than 2,000,000, less than 1,000,000, less than 1,500,000, and less than 800,000. In certain embodiments, preferably, the PHAs generally have a weight-average molecular weight in the range of 100,000 to 700,000. For example, the molecular weight range for PHB and Type 1 PHB copolymers for use in this application are in the range of 200,000 Daltons to 1.5 million Daltons as determined by GPC method and the molecular weight range for Type 2 PHB copolymers for use in the application 20,000 to 1.5 million Daltons.

In certain embodiments, the branched PHA, as discussed in further detail below, can have a linear equivalent weight average molecular weight of from about 150,000 Daltons to about 500,000 Daltons and a polydispersity index of from about 1.0 to about 8.0. As used herein, weight average molecular weight and linear equivalent weight average molecular weight are determined by gel permeation chromatography, using, e.g., chloroform as both the eluent and diluent for the PHA samples. Calibration curves for determining molecular weights are generated using linear polystyrenes as molecular weight standards and a ‘log MW vs. elution volume’ calibration method.

PHAs for use in the methods, compositions and solutions described in this specification are selected from PHB; a PHA blend of PHB with a Type 1 PHB copolymer where the PHB content by weight of PHA in the PHA blend is in the range of 20% to 99% by weight of the PHA in the PHA blend; a PHA blend of PHB with a Type 2 PHB copolymer where the PHB content by weight of the PHA in the PHA blend is in the range of 20% to 99% by weight of the PHA in the PHA blend; a PHA blend of a Type 1 PHB copolymer with a different Type 1 PHB copolymer and where the content of the first Type 1 PHB copolymer is in the range of 20% to 99% by weight of the PHA in the PHA blend; a PHA blend of a Type 1 PHB copolymer with a Type 2 PHA copolymer where the content of the Type 1 PHB copolymer is in the range of 20% to 99% by weight of the PHA in the PHA blend; a PHA blend of PHB with a Type 1 PHB copolymer and a Type 2 PHB copolymer where the PHB content is in the range of 20% to 99% by weight of the PHA in the PHA blend, where the Type 1 PHB copolymer content is in the range of 20% to 99% by weight of the PHA in the PHA blend and where the Type 2 PHB copolymer content is in the range of 20% to 99% by weight of the PHA in the PHA blend.

The PHA blend of PHB with a Type 1 PHB copolymer is a blend of PHB with PHB3HP where the PHB content in the PHA blend is in the range of 20% to 99% by weight of the PHA in the PHA blend and the 3HP content in the PHB3HP is in the range of 7% to 15% by weight of the PHB3HP.

The PHA blend of PHB with a Type 1 PHB copolymer is a blend of PHB with PHB3HV where the PHB content of the PHA blend is in the range of 20% to 99% by weight of the PHA in the PHA blend and the 3HV content in the PHB3HV is in the range of 4% to 22% by weight of the PHB3HV.

The PHA blend of PHB with a Type 1 PHB copolymer is a blend of PHB with PHB4HB where the PHB content of the PHA blend is in the range of 20% to 99% by weight of the PHA in the PHA blend and the 4HB content in the PHB4HB is in the range of 4% to 15% by weight of the PHB4HB.

The PHA blend of PHB with a Type 1 PHB copolymer is a blend of PHB with PHB4HV where the PHB content of the PHA blend is in the range of 20% to 99% by weight of the PHA in the PHA blend and the 4HV content in the PHB4HV is in the range of 4% to 15% by weight of the PHB4HV.

The PHA blend of PHB with a Type 1 PHB copolymer is a blend of PHB with PHB5HV where the PHB content of the PHA blend is in the range of 20% to 90% by weight of the PHA in the PHA blend and the 5HV content in the PHB5HV is in the range of 4% to 15% by weight of the PHB5HV.

The PHA blend of PHB with a Type 1 PHB copolymer is a blend of PHB with PHB3HH where the PHB content of the PHA blend is in the range of 20% to 90% by weight of the PHA in the PHA blend and the 3HH content in the PHB3HH is in the range of 4% to 15% by weight of the PHB3HH.

The PHA blend of PHB with a Type 1 PHB copolymer is a blend of PHB with PHB3HX where the PHB content of the PHA blend is in the range of 20% to 90% by weight of the PHA in the PHA blend and the 3HX content in the PHB3HX is in the range of 4% to 15% by weight of the PHB3HX.

The PHA blend is a blend of a Type 1 PHB copolymer selected from the group PHB3HV, PHB3HP, PHB4HB, PHBV, PHV4HV, PHB5HV, PHB3HH and PHB3HX with a second Type 1 PHB copolymer which is different from the first Type 1 PHB copolymer and is selected from the group PHB3HV, PHB3HP, PHB4HB, PHBV, PHV4HV, PHB5HV, PHB3HH and PHB3HX where the content of the First Type 1 PHB copolymer in the PHA blend is in the range of 20% to 99% by weight of the total PHA in the blend.

The PHA blend of PHB with a Type 2 PHB copolymer is a blend of PHB with PHB4HB where the PHB content in the PHA blend is in the range of 20% to 99% by weight of the PHA in the PHA blend and the 4HB content in the PHB4HB is in the range of 20% to 60% by weight of the PHB4HB.

The PHA blend of PHB with a Type 2 PHB copolymer is a blend of PHB with PHB5HV where the PHB content in the PHA blend is in the range of 20% to 99% by weight of the PHA in the PHA blend and the 5HV content in the PHB5HV is in the range of 20% to 60% by weight of the PHB5HV.

The PHA blend of PHB with a Type 2 PHB copolymer is a blend of PHB with PHB3HH where the PHB content in the PHA blend is in the range of 20% to 99% by weight of the PHA in the PHA blend and the 3HH content in the PHB3HH is in the range of 35% to 90% by weight of the PHB3HX.

The PHA blend of PHB with a Type 2 PHB copolymer is a blend of PHB with PHB3HX where the PHB content in the PHA blend is in the range of 20% to 99% by weight of the PHA in the PHA blend and the 3HX content in the PHB3HX is in the range of 35% to 90% by weight of the PHB3HX.

The PHA blend is a blend of PHB with a Type 1 PHB copolymer and a Type 2 PHB copolymer where the PHB content in the PHA blend is in the range of 20% to 99% by weight of the PHA in the PHA blend, the Type 1 PHB copolymer content of the PHA blend is in the range of 20% to 99% by weight of the PHA in the PHA blend and the Type 2 PHB copolymer content in the PHA blend is in the range of 20% to 99% by weight of the PHA in the PHA blend.

For example a PHA blend can have a PHB content in the PHA blend in the range of 20% to 99% by weight of the PHA in the PHA blend, a PHB3HV content in the PHA blend in the range 20% to 99% by weight of the PHA in the PHA blend, where the 3HV content in the PHB3HV is in the range of 3% to 22% by weight of the PHB3HV, and a PHBHX content in the PHA blend in the range of 20% to 99% by weight of the PHA in the PHA blend where the 3HX content in the PHBHX is in the range of 35% to 90% by weight of the PHBHX.

For example a PHA blend can have a PHB content in the PHA blend in the range of 20% to 99% by weight of the PHA in the PHA blend, a PHB3HV content in the PHA blend in the range 20% to 99% by weight of the PHA in the PHA blend, where the 3HV content in the PHB3HV is in the range of 3% to 22% by weight of the PHB3HV, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHB5HV content in the PHA blend in the range of 20% to 99% by weight of the PHA in the PHA blend where the 5HV content in the PHB5HV is in the range of 20% to 60% by weight of the PHB5HV.

For example a PHA blend can have a PHB content in the PHA blend in the range of 20% to 99% by weight of the PHA in the PHA blend, a PHB4HB content in the PHA blend in the range 20% to 99% by weight of the PHA in the PHA blend, where the 4HB content in the PHB4HB is in the range of 4% to 15% by weight of the PHB4HB, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB4HB content in the PHA blend in the range 20% to 99% by weight of the PHA in the PHA blend, where the 4HB content in the PHB4HB is in the range of 4% to 15% by weight of the PHB4HB, and a PHB5HV content in the PHA blend in the range of 20% to 99% by weight of the PHA in the PHA blend and where the 5HV content in the PHB5HV is in the range of 30% to 90% by weight of the PHB5HV.

For example a PHA blend can have a PHB content in the PHA blend in the range of 20% to 99% by weight of the PHA in the PHA blend, a PHB4HB content in the PHA blend in the range 20% to 99% by weight of the PHA in the PHA blend, where the 4HB content in the PHB4HB is in the range of 4% to 15% by weight of the PHB4HB, and a PHB3HX content in the PHA blend in the range of 20% to 99% by weight of the PHA in the PHA blend and where the 3HX content in the PHB3HX is in the range of 35% to 90% by weight of the PHB3HX.

For example a PHA blend can have a PHB content in the PHA blend in the range of 20% to 99% by weight of the PHA in the PHA blend, a PHB4HV content in the PHA blend in the range 20% to 99% by weight of the PHA in the PHA blend, where the 4HV content in the PHB4HV is in the range of 3% to 15% by weight of the PHB4HV, and a PHB5HV content in the PHA blend in the range of 20% to 99% by weight of the PHA in the PHA blend where the 5HV content in the PHB5HV is in the range of 30% to 90% by weight of the PHB5HV.

For example a PHA blend can have a PHB content in the PHA blend in the range of 20% to 99% by weight of the PHA in the PHA blend, a PHB3HH content in the PHA blend in the range 20% to 99% by weight of the PHA in the PHA blend, where the 3HH content in the PHB3HH is in the range of 3% to 15% by weight of the PHB3HH, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB3HH content in the PHA blend in the range 20% to 99% by weight of the PHA in the PHA blend, where the 3HH content in the PHB3HH is in the range of 3% to 15% by weight of the PHB3HH, and a PHB5HV content in the PHA blend in the range of 20% to 99% by weight of the PHA in the PHA blend where the 5HV content in the PHB5HV is in the range of 20% to 60% by weight of the PHB5HV.

For example a PHA blend can have a PHB content in the PHA blend in the range of 20% to 99% by weight of the PHA in the PHA blend, a PHB3HH content in the PHA blend in the range 20% to 99% by weight of the PHA in the PHA blend, where the 3HH content in the PHB3HH is in the range of 3% to 15% by weight of the PHB3HH, and a PHB3HX content in the PHA blend in the range of 20% to 99% by weight of the PHA in the PHA blend where the 3HX content in the PHB3HX is in the range of 35% to 90% by weight of the PHB3HX.

For example a PHA blend can have a PHB content in the PHA blend in the range of 20% to 99% by weight of the PHA in the PHA blend, a PHB3HX content in the PHA blend in the range 20% to 99% by weight of the PHA in the PHA blend, where the 3HX content in the PHB3HX is in the range of 3% to 12% by weight of the PHB3HX, and a PHB3HX content in the PHA blend in the range of 20% to 99% by weight of the PHA in the PHA blend where the 3HX content in the PHB3HX is in the range of 35% to 90% by weight of the PHB3HX.

For example a PHA blend can have a PHB content in the PHA blend in the range of 20% to 99% by weight of the PHA in the PHA blend, a PHB3HX content in the PHA blend in the range 20% to 99% by weight of the PHA in the PHA blend, where the 3HX content in the PHB3HX is in the range of 3% to 12% by weight of the PHB3HX, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB3HX content in the PHA blend in the range 20% to 99% by weight of the PHA in the PHA blend, where the 3HX content in the PHB3HX is in the range of 3% to 12% by weight of the PHB3HX, and a PHB5HV content in the PHA blend in the range of 20% to 99% by weight of the PHA in the PHA blend where the 5HV content in the PHB5HV is in the range of 20% to 60% by weight of the PHB5HV.

As discussed above, the novel blended polyhydroxyalkanoate/amorphous polyhydroxyalkanoate composition of the present invention comprising blends of polyhydroxyalkanoate and amorphous polyhydroxyalkanoate. Optionally additives such as those disclosed below may be used to further change the desired properties of the blended composition of the present invention.

### Additives

In certain embodiments, various additives are added to the suspensions described previously. Such additives may be mixed at a suitable time during the processing of the components for forming the composition. The one or more additives are included in the suspensions to impart one or more selected characteristics to the suspensions and any article made therefrom. Examples of additives that may be included in the present invention include, but are not limited to, heat stabilizers, process stabilizers, light stabilizers, antioxidants, slip/antiblock agents, tackifiers, barrier enhancers such as inorganic materials such as clays, kaolin, micas, carbonates, and organic cellulosic fibers and crystallites (micro and nano scale), pigments, UV absorbers, fillers, lubricants, pigments, dyes, colorants, flow promoters plasticizers, nucleating agents (discussed in further detail below), talc, wax, calcium carbonate radical scavengers, rheology modifiers, cross-linking agents (peroxide based and other), acid and base scavengers, fillers of both organic and inorganic components, water activity modifiers, plasticizers, and other polymeric functional additives or a combination of one or more of the foregoing additives. The branching agent and/or coupling agent is added to one or more of these for easier incorporation into the polymer. For instance, the branching agent and/or coupling agent is mixed with a plasticizer, e.g., a non-reactive plasticizer, e.g., a citric acid ester, and then compounded with the polymer under conditions to induce branching. Examples of suitable fillers include but are not limited to glass fibers and minerals such as precipitated calcium carbonate, ground calcium carbonate, talc, wollastonite, alumina trihydrate, wood flour, ground walnut shells, coconut shells, and rice husk shells and the like. Additionally, polyfunctional coupling agents such as divinyl benzene, triallyl cyanurate, triallyl iso-cyanurate, urethane di-, tri-, and tetraacrylates and methacrylates, and the like may be added. Such coupling agents can be added to one or more of these additives for easier incorporation into the polymer. For instance, the coupling can be mixed with a plasticizer, e.g., a non-reactive plasticizer, e.g., a citric acid ester, and then compounded with the polymer under conditions to induce branching. Other coupling useful in the compositions of invention, for example, compositions of the first, second, third or fourth aspect are hyperbranched or dendritic polyesters, such as dendritic and hyperbranched acrylates, such as urethane acrylate.

Optionally, additives are included in the suspensions of the present invention at a concentration of about 0.05 to about 20% by weight of the total composition. For example, the range in certain embodiments is about 0.05 to about 5% of the total composition. The additive is any compound known to those of skilled in the art to be useful in the production of thermoplastics. Non-limiting examples of additives include, e.g., plasticizers (e.g., to increase flexibility of a thermoplastic composition), antioxidants (e.g., to protect the thermoplastic composition from degradation by ozone or oxygen), ultraviolet stabilizers (e.g., to protect against weathering), lubricants (e.g., to reduce friction), pigments (e.g., to add color to the thermoplastic composition), flame retardants, fillers, reinforcing, mold release, and antistatic agents. It is well within the skilled practitioner's abilities to determine whether an additive should be included in the blended composition of the present invention and, if so, what additive and the amount that should be added to the composition.

In certain embodiments, the polyhydroxyalkanoate suspensions or blended polyhydroxyalkanoate/amorphous suspensions of the present invention include one or more surfactants that will aide in PHA suspension by reducing the tendency for PHA granules to agglomerate. Surfactants are generally used to de-dust, lubricate, reduce surface tension, and/or densify. Examples of surfactants include, but are not limited to mineral oil, castor oil, and soybean oil. One mineral oil surfactant is DRAKEOL® 34 surfactant, available from Penreco (Dickinson, Tex., USA). MAXSPERSE® W-6000 surfactant and W-3000 solid surfactants are available from Chemax Polymer Additives (Piedmont, S.C., USA). Non-ionic surfactants with HLB values ranging from about 2 to about 16 can be used, examples being TWEEN-20 surfactant, TWEEN-65 surfactant, Span-40 surfactant and Span 85 surfactant. Additional examples of of non-ionic surfactants include Ethoxylated non-ionic surfactants such as alcohol ethoxylates, ethoxylated fatty acids, such as those listed under the DOW trade name “Ecosurf,” etc. ; Polysorbates, and other ethoxylated sorbitan esterified with fatty acids; polyethylene block copolymers such as those listed under the DOW trade name of “Tergitol;” other classes of polar group modified aliphatic compounds.

Anionic surfactants include: Sulfate modified aliphatic compounds are useful, including Sodium dodecyl sulfate (SDS, SLS), aliphatic carboxylic acids such as lauric acid, myristic acid, palmitic acid, stearic acid, and oleic acid; fatty acid soaps such as sodium salts or potassium salts of the above aliphatic carboxylic acids; N-acyl-N-methylglycine salts, N-acyl-N-methyl-beta-alanine salts, N-acylglutamic acid salts, polyoxyethylene alkyl ether carboxylic acid salts, acylated peptides, alkylbenzenesulfonic acid salts, alkylnaphthalenesulfonic acid salts, naphthalenesulfonic acid salt-formalin polycondensation products, melaminesulfonic acid salt-formalin polycondensation products, dialkylsulfosuccinic acid ester salts, alkyl sulfosuccinate disalts, polyoxyethylene alkylsulfosuccinic acid disalts, alkylsulfoacetic acid salts, (alpha-olefinsulfonic acid salts, N-acylmethyltaurine salts, sodium dimethyl 5-sulfoisophthalate, sulfated oil, higher alcohol sulfuric acid ester salts, polyoxyethylene alkyl ether sulfuric acid salts, secondary higher alcohol ethoxysulfates, polyoxyethylene alkyl phenyl ether sulfuric acid salts, monoglysulfate, sulfuric acid ester salts of fatty acid alkylolamides, polyoxyethylene alkyl ether phosphoric acid salts, polyoxyethylene alkyl phenyl ether phosphoric acid salts, alkyl phosphoric acid salts, sodium alkylamine oxide bistridecylsulfosuccinates, sodium dioctylsulfosuccinate, sodium dihexylsulfosuccinate, sodium dicyclohexylsulfosuccinate, sodium diamylsulfosuccinate, sodium diisobutylsulfosuccinate, alkylamine guanidine polyoxyethanol, disodium sulfosuccinate ethoxylated alcohol half esters, disodium sulfosuccinate ethoxylated nonylphenol half esters, disodium isodecylsulfosuccinate, disodium N-octadecylsulfosuccinamide, tetrasodium N-(1,2-dicarboxyethyl)-N-octadccylsulfosuccinamide, disodium mono- or didodecyldiphenyl oxide disulfonates, sodium diisopropylnaphthalenesulfonate, and neutralized condensed products from sodium naphthalenesulfonate.

One or more anti-microbial agents can also be added to the compositions and methods of the invention. An anti-microbial is a substance that kills or inhibits the growth of microorganisms such as bacteria, fungi, or protozoans, as well as destroying viruses. Antimicrobial drugs either kill microbes (microbicidal) or prevent the growth of microbes (microbistatic). A wide range of chemical and natural compounds are used as antimicrobials, including but not limited to: organic acids, essential oils, cations and elements (e.g., colloidal silver). Commercial examples include but are not limited to PolySept® Z microbial, UDA and AGION®.

PolySept® Z microbial (available from PolyChem Alloy) is an organic salt based, non-migratory antimicrobial. “UDA” is Urtica dioica agglutinin. AGION® antimicrobial is a silver compound. AMICAL® 48 silver is diiodomethyl p-tolyl sulfone.

In film applications of the blended polyhydroxyalkanoate/amorphous polyhydroxyalkanoate compositions and methods described herein, anti-lock masterbatch is also added. A suitable example is a slip anti-block masterbatch mixture of erucamide (20% by weight) diatomaceous earth (15% by weight) nucleant masterbatch (3% by weight), pelleted into PHA (62% by weight).

### Branched Polyhydroxyalkanoates

The term “branched PHA” refers to a PHA with branching of the chain and/or coupling of two or more chains. Branching on side chains is also contemplated. Branching can be accomplished by various methods. The PHAs described previously can be branched by branching agents by free-radical-induced coupling of the polymer. In certain embodiment, the PHA is branched prior to combination in the method. In other embodiments, the PHA is reacted with peroxide in the methods of the invention. The branching increases the melt strength of the polymer and can impart greater compatibility of the polymeric components of the formulation. PHA can be branched in any of the ways described in U.S. Pat. Nos. 6,620,869, 7,208,535, 6,201,083, 6,156,852, 6,248,862, 6,201,083 and 6,096,810 all of which arc incorporated herein by reference in their entirety.

The polymers of several embodiments of the invention can also be branched according to any of the methods disclosed in International Publication No. WO 2010/008447, titled “Methods For Branching PHA Using Thermolysis” or International Publication No. WO 2010/008445, titled “Branched PHA Compositions, Methods for Their Production, and Use in Applications,” both of which were published in English on Jan. 21, 2010, and designated the United States. These applications are incorporated by reference herein in their entirety.

### Branching Agents

The branching agents, also referred to a free radical initiator, for use in the compositions and methods described herein include organic peroxides. Peroxides are reactive molecules, and can react with linear PHA molecules or previously branched PHA by removing a hydrogen atom from the polymer backbone, leaving behind a radical. PHA molecules having such radicals on their backbone are free to combine with each other, creating branched PHA molecules. Branching agents are selected from any suitable initiator known in the art, such as peroxides, azo-dervatives (e.g., azo-nitriles), peresters, and peroxycarbonates. Suitable peroxides for use in the present invention include, but are not limited to, organic peroxides, for example dialkyl organic peroxides such as 2,5-dimethyl-2,5-di(t-butylperoxy) hexane, 2,5-bis(t-butylperoxy)-2,5-dimethylhexane (available from Akzo Nobel as TRIGANOX 101), 2,5-dimethyl-di(t-butylperoxy)hexyne-3, di-t-butyl peroxide, dicumyl peroxide, benzoyl peroxide, di-t-amyl peroxide, t-amylperoxy-2-ethylhexylcarbonate (TAEC), t-butyl cumyl peroxide, n-butyl-4,4-bis(t-butylperoxy)valerate, 1,1-di(t-butylperoxy)-3,3,5-trimethyl-cyclohexane, 1,1-bis(t-butylperoxy)-3,3,5-trimethylcyclohexane (CPK), 1,1-di(t-butylperoxy)cyclohexane, 1,1-di(t-amylperoxy)-cyclohexane, 2,2-di(t-butylperoxy)butane, ethyl-3,3-di(t-butylperoxy)butyrate, 2,2-di(t-amylperoxy)propane, ethyl-3,3-di(t-amylperoxy)butyrate, t-butylperoxy-acetate, t-amylperoxyacetate, t-butylperoxybenzoate, t-amylperoxybenzoate, di-t-butyldiperoxyphthalate, di-(tert-butylperoxyisopropyl)benzene (VulCup®) and the like. Combinations and mixtures of peroxides can also be used. Examples of free radical initiators include those mentioned herein, as well as those described in, e.g., Polymer Handbook, 3rd Ed., J. Brandrup & E. H. Immergut, John Wiley and Sons, 1989, Ch. 2. Irradiation (e.g., e-beam or gamma irradiation) can also be used to generate PHA branching.

The efficiency of branching and coupling of the polymer(s) can also be significantly enhanced by the dispersion of organic peroxides in a coupling agent, such as a polymerizable (i.e., reactive) plasticizers. The polymerizable plasticizer should contain a reactive functionality, such as a reactive unsaturated double bond, which increases the overall branching and coupling efficiency.

As discussed above, when peroxides decompose, they form very high energy radicals that can extract a hydrogen atom from the polymer backbone. These radicals have short half-lives, thereby limiting the population of branched molecules that is produced during the active time period.

### Coupling Agents

Coupling agent, also referred to as co-agents, used in the methods and compositions of the invention are coupling agents comprising two or more reactive functional groups such as epoxides or double bonds. These coupling agents modify the properties of the polymer. These properties include, but are not limited to, melt strength or toughness. One type of coupling agent is an “epoxy functional compound.” As used herein, “epoxy functional compound” is meant to include compounds with two or more epoxide groups capable of increasing the melt strength of polyhydroxyalkanoate polymers by branching, e.g., end branching as described above.

When an epoxy functional compound is used as the coupling agent in the disclosed methods, a branching agent is optional. As such one embodiment of the invention is a method of branching a starting PHA, comprising reacting a starting PHA with an epoxy functional compound and then further blending this PHA with an amorphous polyhydroxyalkanoate. Alternatively, another embodiment of the invention is a method of branching a starting polyhydroxyalkanoate polymer, comprising reacting a starting PHA, a branching agent and an epoxy functional compound and then further blending this PHA with amorphous polyhydroxyalkanoate. Alternatively, another embodiment of the invention is a method of branching a starting polyhydroxyalkanoate polymer, comprising reacting a starting PHA, and an epoxy functional compound in the absence of a branching agent and then further blending this PHA with amorphous polyhydroxyalkanoate. Such epoxy functional compounds can include epoxy-functional, styrene-acrylic polymers (such as, but not limited to, e.g., MP-40 (Kaneka)), acrylic and/or polyolefin copolymers and oligomers containing glycidyl groups incorporated as side chains (poly(ethylene-glycidyl methacrylate-co-methacrylate)), and epoxidized oils (such as, but not limited to, e.g., epoxidized soybean, olive, linseed, palm, peanut, coconut, seaweed, cod liver oils, or mixtures thereof, e.g., Merginat® ESBO (Hobum, Hamburg, Germany) and EDENOL® B 316 (Cognis, Dusseldorf, Germany)).

For example, reactive acrylics or functional acrylics coupling agents are used to increase the molecular weight of the polymer in the branched polymer compositions described herein. Such coupling agents are sold commercially. One such compound is MP-40 (Kaneka) and still another is Petra line from Honeywell, see for example, U.S. Pat. No. 5,723,730. Such polymers are often used in plastic recycling (e.g., in recycling of polyethylene terephthalate) to increase the molecular weight (or to mimic the increase of molecular weight) of the polymer being recycled.

Fatty acid esters or naturally occurring oils containing epoxy groups (epoxidized) and/or chemical unsaturation can also be used. Examples of naturally occurring oils are olive oil, linseed oil, soybean oil, palm oil, peanut oil, coconut oil, seaweed oil, cod liver oil, or a mixture of these compounds. Particular preference is given to epoxidized soybean oil (e.g., Merginat® ESBO from Hobum, Hamburg, or EDENOL® B 316 from Cognis, Dusseldorf), but others may also be used.

Another type of coupling agent are agents with two or more double bonds. Coupling agents with two or more double bond coupling PHAs by after reacting at the double bonds. Examples of these include: diallyl phthalate, pentaerythritol urethane acrylate, tetraacrylate, trimethylolpropane triacrylate, pentaerythritol triacrylate, dipentaerythritol pentaacrylate, diethylene glycol dimethacrylate, bis(2-methacryloxyethyl)phosphate.

In general, it appears that compounds with terminal epoxides may perform better than those with epoxide groups located elsewhere on the molecule.

Compounds having a relatively high number of end groups are the most desirable. Molecular weight may also play a role in this regard, and compounds with higher numbers of end groups relative to their molecular weight (e.g., the Joncryl® resins are in the 3000-4000 g/mol range) are likely to perform better than compounds with fewer end groups relative to their molecular weight (e.g., the Omnova products have molecular weights in the 100,000-800,000 g/mol range).

### Nucleating Agents

For instance, an optional nucleating agent is added to the blended composition to aid in its crystallization. Nucleating agents for various polymers are simple substances, metal compounds including composite oxides, for example, carbon black, calcium carbonate, synthesized silicic acid and salts, silica, zinc white, clay, kaolin, basic magnesium carbonate, mica, talc, quartz powder, diatomite, dolomite powder, titanium oxide, zinc oxide, antimony oxide, barium sulfate, calcium sulfate, alumina, calcium silicate, metal salts of organophosphates, and boron nitride; low-molecular organic compounds having a metal carboxylate group, for example, metal salts of such as octylic acid, toluic acid, heptanoic acid, pelargonic acid, lauric acid, myristic acid, palmitic acid, stearic acid, behenic acid, cerotic acid, montanic acid, melissic acid, benzoic acid, p-tert-butylbenzoic acid, terephthalic acid, terephthalic acid monomethyl ester, isophthalic acid, and isophthalic acid monomethyl ester; high-molecular organic compounds having a metal carboxylate group, for example, metal salts of such as: carboxyl-group-containing polyethylene obtained by oxidation of polyethylene; carboxyl-group-containing polypropylene obtained by oxidation of polypropylene; copolymers of olefins, such as ethylene, propylene and butene-1, with acrylic or methacrylic acid; copolymers of styrene with acrylic or methacrylic acid; copolymers of olefins with maleic anhydride; and copolymers of styrene with maleic anhydride; high-molecular organic compounds, for example: alpha-olefins branched at their 3-position carbon atom and having no fewer than 5 carbon atoms, such as 3,3 dimethylbutene-1,3-methylbutene-1,3-methylpentene-1,3-methylhexene-1, and 3,5,5-trimethylhexene-1; polymers of vinylcycloalkanes such as vinylcyclopentane, vinylcyclohexane, and vinylnorbornane; polyalkylene glycols such as polyethylene glycol and polypropylene glycol; poly(glycolic acid); cellulose; cellulose esters; and cellulose ethers; phosphoric or phosphorous acid and its metal salts, such as diphenyl phosphate, diphenyl phosphite, metal salts of bis(4-tert-butylphenyl) phosphate, and methylene bis-(2,4-tert-butylphenyl)phosphate; sorbitol derivatives such as bis(p-methylbenzylidene)sorbitol and bis(p-ethylbenzylidene)sorbitol; and thioglycolic anhydride, p-toluenesulfonic acid and its metal salts. The above nucleating agents may be used either alone or in combinations with each other. In particular embodiments, the nucleating agent is cyanuric acid. In certain embodiments, the nucleating agent can also be another polymer (e.g., polymeric nucleating agents such as PHB).

In certain embodiments, the nucleating agent is selected from: cyanuric acid, carbon black, mica talc, silica, boron nitride, clay, calcium carbonate, synthesized silicic acid and salts, metal salts of organophosphates, and kaolin, or combinations thereof. In particular embodiments, the nucleating agent is cyanuric acid.

In various embodiments, where the nucleating agent is dispersed in a liquid carrier, the liquid carrier is a plasticizer, e.g., a citric compound or an adipic compound, e.g., acetylcitrate tributyrate ((CITROFLEX® A4) plasticizer, Vertellus, Inc., High Point, N.C.), or DBEEA (dibutoxyethoxyethyl adipate), a surfactant, e.g., Triton X-100 surfactant, TWEEN-20 surfactant, TWEEN-65 surfactant, Span-40 surfactant or Span 85 surfactant, a lubricant, a volatile liquid, e.g., chloroform, heptane, or pentane, an organic liquid or water.

In other embodiments, the nucleating agent is aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole.

In particular embodiments, the nucleating agent can include aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole. The nucleating agent can be a nucleating agent as described in U.S. Pat. App. Pub. 2005/0209377, by Allen Padwa, which is herein incorporated by reference in its entirety.

Another nucleating agent for use in the blended compositions and methods described herein in which the nucleating agent(s) are milled as described in WO 2009/129499 titled “Nucleating Agents for Polyhydroxyalkanoates,” which was published in English and designated the United States, which is herein incorporated by reference in its entirety. Briefly, the nucleating agent is milled in a liquid carrier until at least 5% of the cumulative solid volume of the nucleating agent exists as particles with a particle size of 5 microns or less. The liquid carrier allows the nucleating agent to be wet milled. In other embodiments, the nucleating agent is milled in liquid carrier until at least 10% of the cumulative solid volume, at least 20% of the cumulative solid volume, at least 30% or at least 40%-50% of the nucleating agent can exist as particles with a particle size of 5 microns or less, 2 microns or less or 1 micron or less. In alternative embodiments, the nucleating agents is milled by other methods, such as jet milling and the like. Additionally, other methods are utilized that reduce the particle size.

The cumulative solid volume of particles is the combined volume of the particles in dry form in the absence of any other substance. The cumulative solid volume of the particles is determined by determining the volume of the particles before dispersing them in a polymer or liquid carrier by, for example, pouring them dry into a graduated cylinder or other suitable device for measuring volume. Alternatively, cumulative solid volume is determined by light scattering.

Suitable heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Suitable antistatic agents include, for example, glycerol monostearate, sodium stearyl sulfonate, sodium dodecylbenzenesulfonate or the like, or combinations of the foregoing antistatic agents. In one embodiment, carbon fibers, carbon nanofibers, carbon nanotubes, carbon black, or any combination of the foregoing may be used in a polymeric resin containing chemical antistatic agents to render the composition electrostatically dissipative.

Suitable surface releasing agents include for example, metal stearate, stearyl stearate, pentaerythritol tetrastearate, beeswax, montan wax, paraffin wax, or the like, or combinations including at least one of the foregoing mold release agents. Surface releasing agents are generally used in amounts of from 0.1 to 1.0 parts by weight, based on 100 parts by weight of the total composition, excluding any filler.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL® 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight based on 100 parts by weight of the total composition, excluding any filler.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of from 1 to 10 parts by weight, based on 100 parts by weight based on 100 parts by weight of the total composition, excluding any filler.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4-biphenyl)-5-(4-t-butylphenyl)-1,3,4-oxadiazole; 2-(4-biphenyl)-6-phenylbenzoxazole-1,3; 2,5-Bis-(4-biphenyl)-1)-1,3,4-oxadiazole; 2,5-bis-(4-biphenyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IRS; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of from 0.1 to 5 parts by weight, based on 100 parts by weight of the total composition, excluding any filler.

Suitable pigments include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), naphthalenetetracarboxylic derivatives, monoazo and diazo pigments, triarylmethanes, aminoketones, bis(styryl)biphenyl derivatives, and the like, as well as combinations including at least one of the foregoing colorants. Colorants are generally used in amounts of from 0.1 to 5 parts by weight, based on 100 parts by weight of the total composition, excluding any filler.

Additionally, materials to improve flow and other properties may be added to the composition, such as low molecular weight hydrocarbon resins. Particularly useful classes of low molecular weight hydrocarbon resins are those derived from petroleum C5 to C9 feedstock that are derived from unsaturated C5 to C9 monomers obtained from petroleum cracking. Non-limiting examples include olefins, e.g. pentenes, hexenes, heptenes and the like; diolefins, e.g. pentadienes, hexadienes and the like; cyclic olefins and diolefins, e.g. cyclopentene, cyclopentadiene, cyclohexene, cyclohexadiene, methylcyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

### Application of the Blended Polyhydroxyalkanoate/amorphous Polyhydroxyalkanoate Compositions

In certain embodiments, the PHA and amorphous polyhydroxyalkanoate components are in the form of a fine particle size powder, the blended composition of the present invention is prepared by dry-blending the components at a pre-determined ratio and subjecting this mixture to twin-screw extrusion.

The novel suspension described herein can be used for packaging coating on a number of useful article such as, but not limited to, plates, bowls, cups, to go containers.

In any of the compositions, methods, processes or articles described herein, the PHA and amorphous polyhydroxyalkanoate components are preferably in the form of a fine particle size powder and used separately or combined by mixing or blending.

The products disclosed above all contain a major component (PHA) which if ingested by an animal can be metabolized by the animal and used as a source of energy. Consequently, the added benefit of the products is that they also serve as a food product for living organisms. The term animal includes all animals including human. Examples of animals are non-ruminants, and ruminants. Ruminant animals include, for example, animals such as sheep, goat, and cattle, e.g. cow such as beef cattle and dairy cows. In a particular embodiment, the animal is a non-ruminant animal. Non-ruminant animals include pet animals, e.g. horses, cats and dogs; mono-gastric animals, e.g. pig or swine (including, but not limited to, piglets, growing pigs, and sows); poultry such as turkeys, ducks and chickens (including but not limited to broiler chicks, layers); fish (including but not limited to salmon, trout, tilapia, catfish and carp); seabirds (including but not limited to seagulls, pelicans, terns) sea animals (including but not limited to whales, turtles, dolphins, sharks) and crustaceans (including but not limited to shrimp and prawn).

Having disclosed several embodiments, it will be recognized by those skilled in the art that various modifications, alternative constructions, and equivalents may be used without departing from the spirit of the disclosed embodiments. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits arc also included.

As used herein and in the appended claims, the singular forms “a”, “an”, and “the” include plural referents unless the context clearly dictates otherwise. Thus, for example, reference to “a process” includes a plurality of such processes and reference to “the dielectric material” includes reference to one or more dielectric materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A product in the form of a food service item comprising a layer forming a moisture barrier, said product comprising:
a paperboard substrate having two surfaces wherein one of said surfaces comes in contact with food;
the moisture barrier layer coated directly on said surface of said paperboard that comes in contact with food and comprising at least one polyester polymer having a final thickness in the range of from 0.1 to 2.0 mil thickness dry weight.

2. The product of claim 1, wherein said polyester polymer has a weight basis of about 3 to 70 grams per square meter coat weight basis.

3. The product of claim 1, wherein said moisture barrier layer is applied to said paperboard substrate as a spray.

4. The product of claim 3, wherein said spray comprises an aqueous solution of PHA.

5. The product of claim 4, wherein said spray comprises an aqueous solution of PHA blended with amorphous PHA (aPHA).

6. The product of claim 5, wherein said PHA in the PHA blend is in the range of 70% to 97.5% by weight of the combined content of the PHAs in the PHA blend, and the content of the aPHA in the PHA blend is in the range of 2.5% to 30% by weight of the combined content of the PHAs in the PHA blend.

7. The product of claim 6, wherein said amorphous polymer is a PHA having a glass transition temperature (Tg) less than 20° C., and a melting temperature (TM) of 80° C. to 180°.

8. The product of claim 1, further comprising: a nucleating agent; a free radical initiator, a branching agent, a coupling agent/coagent, thermal stabilizers, antioxidants, slip agents, colorants and other functional additives.

9. The product of any one of claims 1 to 8, wherein said polyester polymer is selected from a poly(3-hydroxybutyrate) homopolymer (PHB), polyhydroxyvalerate (PHV), polyhydroxybutyrate-covalerate (PHBV), polyhydroxyhexanoate (PHHx), poly 3-hydroxyalkanoates (e.g., poly 3-hydroxypropionate (hereinafter referred to as P3HP), poly 3-hydroxybutyrate (PHB) and poly 3-hydroxyvalerate), poly 4-hydroxyalkanoates (e.g., poly 4-hydroxybutyrate (P4HB), or poly 4-hydroxyvalerate (P4HV)) and poly 5-hydroxyalkanoates (e.g., poly 5-hydroxyvalerate (P5HV)), poly 3-hydroxybutyrate-co-3-hydroxypropionate (PHB3HP), poly 3-hydroxybutyrate-co-4-hydroxybutyrate (PHB4HB), poly 3-hydroxybutyrate-co-4-hydroxyvalerate (PHB4HV), poly 3-hydroxybutyrate-co-3-hydroxyvalerate (PHB3HV), poly 3-hydroxybutyrate-co-3-hydroxyhexanoate (PHB3HH) and poly 3-hydroxybutyrate-co-5-hydroxyvalerate (PHB5HV) and various combinations thereof, including polymer blends.

10. The product of any one of claims 1 to 9, wherein said paperboard substrate is in the shape of a plate.

11. The product of any one of claims 1 to 9, wherein said paperboard substrate is in the shape of a cup.

12. The product of any one of claims 1 to 9, wherein said paperboard substrate is in the shape of a to go container.

13. A biodegradable aqueous dispersion for coating food contact substrates, the dispersion comprising: PHA blended with an amorphous PHA (aPHA) wherein: the content of the PHA in said blend is in the range of 70% to 97.5% by weight of the combined content of the PHAs in said blend, the content of the aPHA in said blend is in the range of 2.5% to 30% by weight of the combined content of the PHAs in said blend.
